(19) United States
(12) Patent Application Publication
(10) Pub. No.: US 2012/0180379 A1
(43) Pub. Date: Jul. 19, 2012

(54) FLYTRAP

(76) Inventor: Chung-Peng TIEN, Caotun Township (TW)

(21) Appl. No.: 13/009,596

(22) Filed: Jan. 19, 2011

(51) Int. Cl. A01M 1/22

(52) U.S. Cl. 43/112

(57) ABSTRACT

A flytrap includes at least a collection barrel, a main unit having an upper seat, a lower seat, an electrode net, a safety net and a guiding plate, a fixing element which is deployed in the electrode net to install a bait, as well as a circuit module. By the abovementioned structural design, the bait is installed in the fixing element and an odor of the bait is used to attract files to approach the electrode net. Next, the flies are shocked electrically with a high voltage on the electrode net and finally, the dead or paralyzed flies are gathered in the collection barrel.

### BACKGROUND OF THE INVENTION

(a) Field of the Invention

The present invention relates to a technology of capturing flies, and more particularly to a flytrap which utilizes an odor to attract flies to approach and electroshocks the flies with an electrode grid discharging a low current and a high voltage, followed by gathering the dead or paralyzed flies in a collection barrel.

(b) Description of the Prior Art

In addition to easily becoming a medium for spreading diseases, Cyclorrhapha such as flies or fruit flies can be a major factor to affect hygiene of daily foods and fruits.

There are generally several kinds of conventional ways to capture flies, as follows. The first one is to use a flyswatter to hit flies standing on a ground, a wall or a surface of other object. However, this swatting depends upon a person to hit the flies one by one, which not only extremely wastes time and labor, but distracts the person from working. Besides, the flies captured are limited. Therefore, this method indeed does not comply with demands. The second method uses a flypaper, wherein a layer of strong alluring adhesive is coated on a piece of paper to stick the flies standing on that paper. As the flypaper is adhered completely with the flies, it is not pleasant to see. Furthermore, the flypaper can be easily touched by children or pets that it is not hygienic. Hence, this method can cause a lot of troubles to a user. The third method is to spray a chemical insecticide into a herd of flies or the flies standing on a ground or a wall. As the effect of the insecticide is limited after diffusion, the insecticide can be easily inhaled by the user and the insecticide can be easily remained when the insecticide is sprayed on an object, a rather large risk to health of the user will be resulted, the side effect of the insecticide is too strong and the effect of capturing the flies is not significant.

### SUMMARY OF THE INVENTION

The object of the present invention is to provide a flytrap which utilizes primarily a bait to attract flies to approach and electroshocks the flies with an electrode grid discharging a low current and a low voltage, so as to effectively capture and gather the flies, thereby preventing from vector-borne infection.

To achieve the abovementioned object, the flytrap of the present invention includes at least:

a collection barrel, an upper side of which is provided with an opening and an interior of which is provided with a holding space;

a main unit which is deployed above the collection barrel to electroshock the flies and is constituted at least by an upper seat, a lower seat, a guiding plate, an electrode net and a safety net, with the said upper seat being provided with a groove and a fixing hole, the said electrode net and safety net being provided between the upper seat and the lower seat, the lower seat being provided with plural through-holes between the electrode net and the safety net, the said guiding plate being provided below the lower seat, and an interior of the guiding plate being provided with a receiving chamber connecting with the through-holes;

a fixing element which is fixed on the fixing hole of the upper seat to install a bait; and

a circuit module which is put in the groove of the upper seat and is provided with an electrically connected electrode net and an electrically connected power source to produce a low current and a high voltage for outputting to the electrode net.

Accordingly, the flytrap utilizes the odor to attract flies to approach, uses the electrode grid which discharges a low current and a high voltage to electroshock the flies and gathers the dead or paralyzed flies in the collection barrel.

In the abovementioned flytrap, the said fixing element can be in a shape of filter screen, single fishhook or plural fishhooks.

In the abovementioned flytrap, the said filter-screen-shaped fixing element includes an annular portion, an upper end of which is provided with a handle and a lower end of which is provided with a holding space. Besides, an annular wall of the holding space is provided with air holes.

In the abovementioned flytrap, the said single-fishhook-shaped fixing element includes an annular portion, an upper end of which is provided with a handle and a lower end of which is provided with a J-shaped hook.

In the abovementioned flytrap, the said multi-fishhook-shaped fixing element includes an annular portion, an upper end of which is provided with a handle and a lower end of which is provided with a hanger rod, with the hanger rod being provided with plural V-shaped hooks.

In the abovementioned flytrap, the said collection barrel can be in all kinds of shapes.

In the abovementioned flytrap, the said electrode net and safety net are provided annularly.

In the abovementioned flytrap, the said through-holes of the lower seat are in a shape of fan.

In the abovementioned flytrap, the said guiding plate is in a shape of funnel.

In the abovementioned flytrap, the said upper seat is provided with an upper cap.

In the abovementioned flytrap, the said collection barrel is provided with a support bracket having a stepped hole to fix the lower seat of the main unit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional external view of a first embodiment of the present invention.

FIG. 2 shows a top view of FIG. 1 of the present invention.

FIG. 3 shows a cutaway view of FIG. 2 along the line A-A of the present invention.

FIG. 4 shows a three-dimensional exploded view of FIG. 1 of the present invention.

FIG. 5 shows a cutaway view of FIG. 4 of the present invention.

FIG. 6 shows a three-dimensional external view of a second embodiment of the present invention.

FIG. 7 shows a local exploded view of FIG. 6 of the present invention.

FIG. 8 shows a cutaway view of a fixing element in a shape of filter screen of the present invention.

FIG. 9 shows a cutaway view of a fixing element in a shape of single fishhook of the present invention.

FIG. 10 shows a cutaway view of a fixing element in a shape of plural fishhooks of the present invention.

### DETAILED DESCRIPTION OF THE PREFERRED EMBODIMENTS

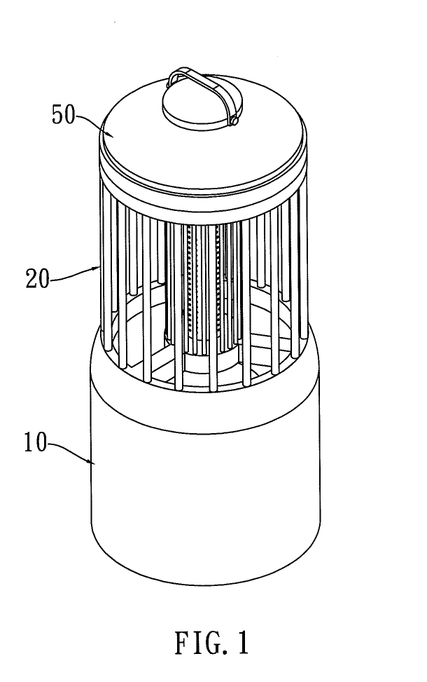

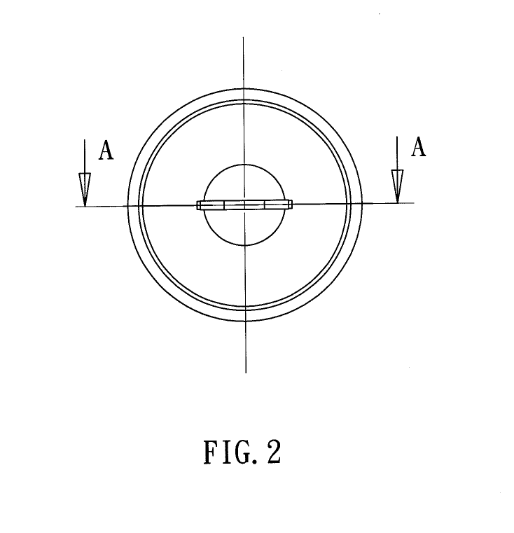

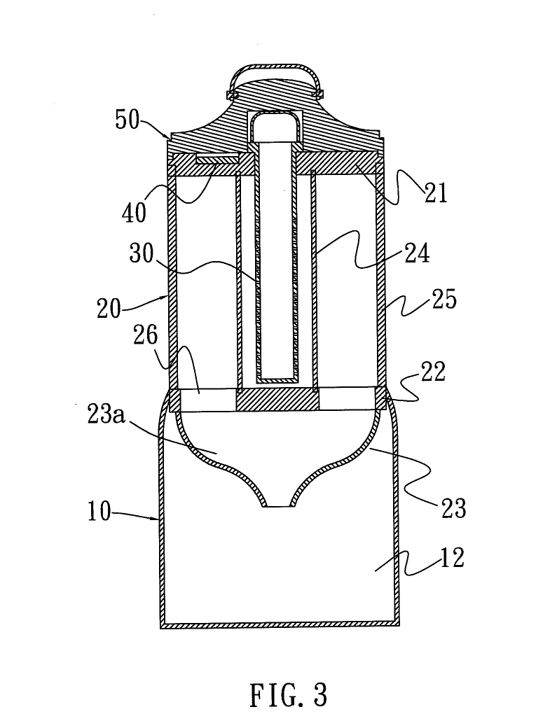

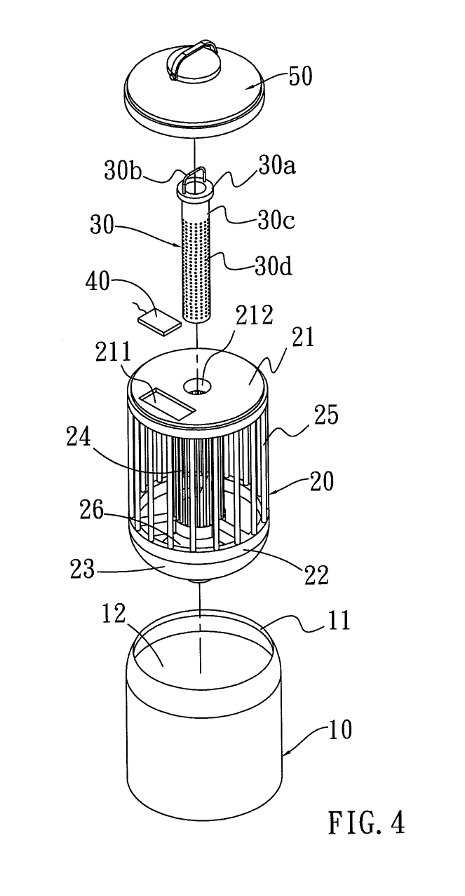

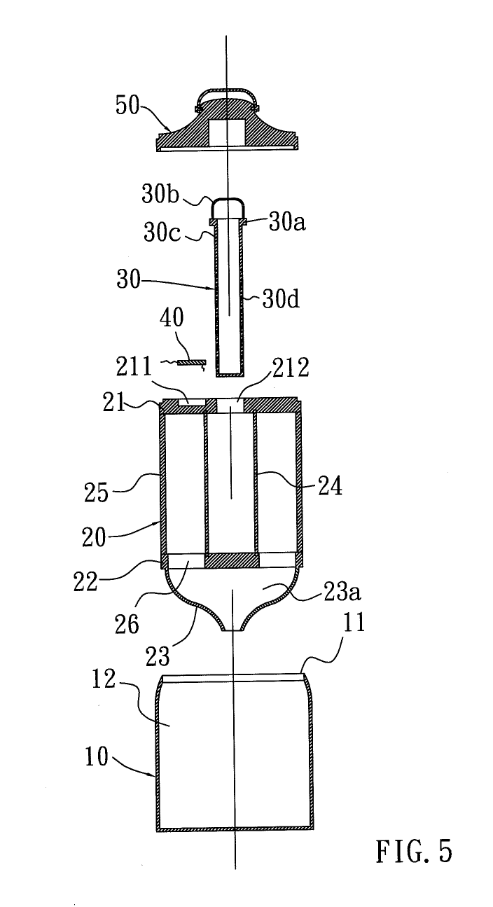

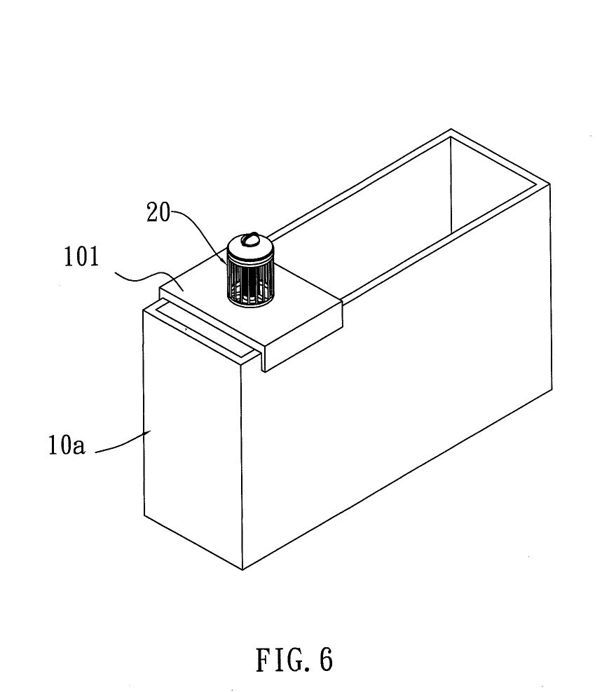

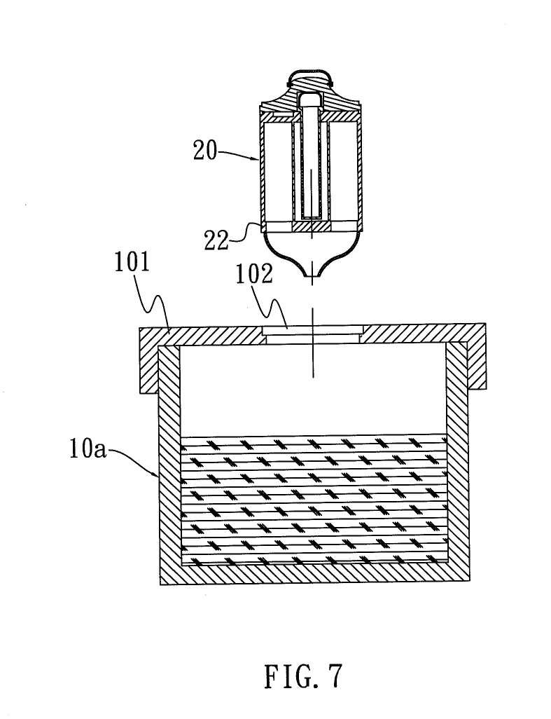

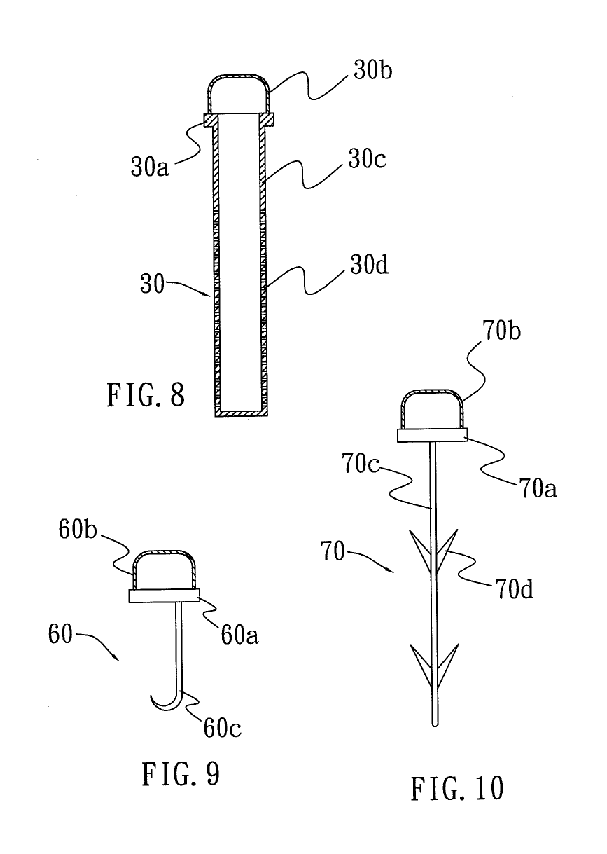

Referring to FIG. 1 and FIG. 6, FIG. 1 shows a three-dimensional external view of a first preferred embodiment of the present invention and FIG. 6 shows a three-dimensional external view of a second preferred embodiment of the present invention. As shown in FIG. 1, the present invention can be hung or put on a ground for use indoors or outdoors; whereas, as in FIG. 6 and FIG. 7, the present invention can be put on a fish tank to attract and capture flies or fruit flies. In FIGS. 2 to 5 of the first embodiment, FIG. 2 is a top view of FIG. 1, FIG. 3 is a cutaway view of FIG. 2 along the line A-A, FIG. 4 is a three-dimensional exploded view of FIG. 1 and FIG. 5 is a cutaway view of FIG. 4. A flytrap of the present invention comprises at least a collection barrel 10, a main unit 20, a fixing element 30, 60, 70 as shown in FIGS. 8 to 10, and a circuit module 40.

In FIGS. 1 to 5, the flytrap of the present invention includes the collection barrel 10 to gather flies that have been shocked electrically. An upper side of the said collection barrel 10 is provided with an opening 11 and an interior of the collection barrel 10 is provided with a holding space 12. The collection barrel 10 can be in all kinds of shapes; in the first embodiment, the collection barrel 10 is in a shape of round cylinder as shown in FIG. 4, and, in a second embodiment, the collection barrel 10a is in a shape of fish tank as shown in FIG. 6, with that the flies that have been shocked electrically can fall into the fish tank directly to serve as a natural feed for fishes.

Referring to FIGS. 1 to 5 again, for the flytrap of the present invention, the upper side of the collection barrel 10 is provided with the main unit 20 to electroshock the flies. The said main unit 20 is constituted at least by an upper seat 21, a lower seat 22, a guiding plate 23, an electrode net 24 and a safety net 25. In the present embodiment, the upper seat 21 and the lower seat 22 are in a shape of round disc, the guiding plate 23 is in a shape of funnel, the upper seat 21 is provided with a groove 211 and a fixing hole 212, the electrode net 24 and the safety net 25 are provided between the upper seat 21 and the lower seat 22, the lower seat 22 is provided with plural through-holes 26 between the electrode net 24 and the safety net 25, the electrode net 24 is able to output a low current and a high voltage to electroshock the flies, the guiding plate 23 is provided below the lower seat 22 and an interior of the guiding plate 23 is provided with a receiving chamber 23a which is connected with the through-holes 26. The flies that have been shocked electrically can fall into the receiving chamber 23a of the guiding plate 23 from the through-holes 26 and then slide into the holding space 12 of the collection barrel 10.

In addition, referring to FIGS. 3, 4, 5, 8, 9 and 10, the flytrap of the present invention includes the fixing element 30, 60, 70 to install a bait. The fixing element 30, 60, 70 is provided in the electrode net 24 of the main unit 20 to attract the flies to approach. In the first and second preferred embodiments, the fixing element 30, 60, 70 can be in a shape of filter screen, single fishhook or plural fishhooks, wherein FIG. 8 shows a preferred embodiment of the filter-screen-shaped fixing element 30, FIG. 9 shows a preferred embodiment of the single-fishhook-shaped fixing element 60 and FIG. 10 shows a preferred embodiment of the multi-fishhook-shaped fixing element 70. In FIG. 8, the filter-screen-shaped fixing element 30 includes an annular portion 30a, an upper end of which is provided with a handle 30b and a lower end of which is provided with a holding barrel 30c. An annular wall of the holding barrel 30c is provided with air holes 30d. In FIG. 4, the annular portion 30a is fixed on the fixing hole 212 of the upper seat 21, allowing the holding barrel 30c to be located in the electrode net 24. The holding barrel 30c can be installed with the bait to attract the flies. In FIG. 9, on the other hand, the single-fishhook-shaped fixing element 60 includes an annular portion 60a, an upper end of which is provided with a handle 60b and a lower end of which is provided with a J-shaped hook 60c. In addition, in FIG. 10, the multi-fishhook-shaped fixing element 70 includes an annular portion 70a, an upper end of which is provided with a handle 70b and a lower end of which is provided with a hanger rod 70c. The hanger rod 70c is provided with plural V-shaped hooks 70d.

In FIGS. 3 to 5, the flytrap of the present invention includes the circuit module 40 which is put in the groove 211 of the upper seat 21. The circuit module 40 is provided with an electrically connected electrode net and an electrically connected power source to produce a low current and a high voltage which are outputted to the electrode net 24.

In the flytrap of the present invention, the collection barrel 10 can be in all kinds of shapes, such as the round-cylinder-shaped collection barrel 10 in FIG. 4 or the rectangular collection barrel 10a in FIG. 6 and FIG. 7. Besides, the electrode net 24 and the safety net 25 are provide annularly and the through-holes 26 of the lower seat 22 are in a shape of fan.

Furthermore, to prevent an odor of the bait from dissipating upward, when implementing, an upper side of the upper seat 21 can be provided with an upper cap 50 to extend a time of use of the bait, as shown in FIGS. 1 to 5.

On the other hand, in the second preferred embodiment as shown in FIG. 6 and FIG. 7, the collection barrel 10a is further provided with a support bracket 101 on which is provided with a stepped hole 102 to fix the lower seat 22 of the main unit 20. The collection barrel 10a can be an ordinary family fish tank, wherein the collection barrel 10a can be emplaced with the support bracket 101 and then the flytrap is fixed on the support bracket 101 to capture the indoor flies as the natural feed of aquarium fishes.

Accordingly, when the holding barrel 30c, J-shaped hook 60c or V-shaped hooks 70d of the fixing element 30, 60, 70 is installed with the bait, the odor of bait can be utilized to attract the flies to enter into the electrode net 24 and then the flies will be shocked electrically with the high voltage by the electrode net 24 and drop into the collection barrel 10 from the through-holes 26 along the receiving chamber 23a of the guiding plate 23.

The flytrap of the present invention utilizes the bait to attract the flies to fly into the main unit 20 and then the flies will be shocked electrically by the electrode net 24. Therefore, the flies can be rapidly and effectively captured and gathered to prevent from vector-borne infection, which is provided with an effect of improvement.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A flytrap comprising:
a collection barrel, an upper side of which is provided with an opening and an interior of which is provided with a holding space;
a main unit which is deployed above the collection barrel to electroshock flies and is constituted by an upper seat, a lower seat, a guiding plate, an electrode net and a safety net, with the upper seat being provided with a groove and a fixing hole, the electrode net and the safety net being provided between the upper seat and the lower seat, the lower seat being provided with plural through-holes between the electrode net and the safety net, the guiding plate being provided below the lower seat, and an interior of the guiding plate being provided with a receiving chamber connecting with the through-holes;
a fixing element which is put in the electrode net of the main unit to install a bait; and
a circuit module which is put in the groove of the upper seat, and is provided with an electrically connected electrode net and an electrically connected power source to produce a low current and a high voltage that are outputted to the electrode net;
accordingly, the flytrap utilizing an odor to attract flies to approach, using the electrode grid discharging a low current and a high voltage to electroshock the flies and then gathering the dead or paralyzed flies in the collection barrel.

2. The flytrap according to claim 1, wherein the fixing element is in a shape of filter screen, single fishhook or plural fishhooks.

3. The flytrap according to claim 2, wherein the filter-screen-shaped fixing element includes an annular portion, an upper end of which is provided with a handle and a lower end of which is provided with a holding barrel, with air holes being provided on an annular wall of the holding barrel.

4. The flytrap according to claim 2, wherein the single-fishhook-shaped fixing element includes an annular portion, an upper end of which is provided with a handle and a lower end of which is provided with a J-shaped hook.

5. The flytrap according to claim 2, wherein the multi-fishhook-shaped fixing element includes an annular portion, an upper end of which is provided with a handle and a lower end of which is provided with a hanger rod, with the hanger rod being provided with plural V-shaped hooks.

6. The flytrap according to claim 1, wherein the guiding plate is in a shape of funnel.

7. The flytrap according to claim 1, wherein the collection barrel is in all kinds of shapes.

8. The flytrap according to claim 1, wherein the electrode net and the safety net are provided annularly.

9. The flytrap according to claim 1, wherein the through-holes of the lower seat are in a shape of fan.

10. The flytrap according to claim 1, wherein the upper seat is provided with an upper cap.

11. The flytrap according to claim 1, wherein the collection barrel is provided with a support bracket having a stepped hole to fix the lower seat of the main unit.
